(19) United States
(12) Patent Application Publication
(10) Pub. No.: US 2026/0054970 A1
(43) Pub. Date: Feb. 26, 2026

(54) ROTARY TELESCOPIC HANDLER

(71) Applicant: MAGNI REAL ESTATE S.R.L., CASTELFRANCO EMILIA (IT)

(72) Inventor: Riccardo MAGNI, MODENA (IT)

(73) Assignee: MAGNI REAL ESTATE S.R.L., CASTELFRANCO EMILIA (IT)

(21) Appl. No.: 19/100,777

(22) PCT Filed: Aug. 3, 2023
(86) PCT No.: PCT/EP2023/071568

§ 371 Date: Feb. 3, 2025

(30) Foreign Application Priority Data
Aug. 4, 2022 (IT) 102022000016590

(51) Int. Cl. B66F 9/065; B60R 3/00; B66F 9/075; B66F 9/24

(52) U.S. Cl. CPC B66F 9/0655; B60R 3/00; B66F 9/07504; B66F 9/0755; B66F 9/24

(57) ABSTRACT

A rotary telescopic handler, which comprises at least one vehicle, which can move on the ground and is provided with at least a ladder arranged along one of its side walls, and a rotating assembly that comprises at least one telescopic boom, and a cab; the handler comprises an electronic unit associated with a respective actuation device, which can be activated selectively by an operator; the unit is configured to actuate the rotation of the assembly with respect to the vehicle about the vertical axis and is provided with instructions for the automatic rotation of the assembly with respect to the vehicle, following the activation of the device, to at least a first predefined arrangement, for facilitated access to the cab, wherein a door for access to the cab faces the ladder and is proximate thereto.

The present invention relates to a rotary telescopic handler.

As is known, telescopic handlers are self-propelled works vehicles used for the handling of heavy and/or bulky goods and equipment, offering the possibility of maintenance, repair, and/or assembly work at high elevations or in any case in contexts that are awkward in various ways.

In this field, therefore, telescopic handlers have a general configuration that is by now outlined, which first and foremost provides for a vehicle or truck mounted on wheels or tracks, in order to allow the machine to travel over more or less rough roads and terrains and reach the place of intervention.

The vehicle directly or indirectly supports a telescopic boom, which can rotate about a horizontal axis and to the free end of which accessories of various types can be coupled, indeed depending on the nature of the intervention to be carried out by the handler.

In an embodiment of considerable practical interest, the telescopic boom and the cab designed to accommodate an operator are part of a rotatable structure, which is supported by the vehicle with the possibility of rotation about a vertical axis.

In this embodiment, the machine is usually termed “rotary telescopic handler” and is very successful commercially because of its greater versatility, since the possibility to rotate the rotatable structure significantly increases the working space of the handler, i.e., the set of points that can be reached by the accessory, while the vehicle is stationary. This is particularly appreciated in all contexts in which the vehicle's maneuvering area is limited by obstacles present on the ground or by the shape of the terrain and/or surrounding infrastructure.

To get into or out of the cab, which is supported by the underlying vehicle and thus located at a significant distance from the ground, the operator has at least one ladder, arranged along one side of the vehicle. Usually, the position of the ladder is chosen so as to place it directly below the cab access door when the handler is in the arrangement assumed during road travel.

In greater detail, in this arrangement the telescopic boom is oriented along the direction of travel and the cab, arranged laterally to said boom, is kept aligned with the side of the underlying vehicle, with the lateral wall along which the door is indeed provided.

The alignment between the lateral wall of the cab and the side of the vehicle allows to maximize the size of the cab (and therefore the space available to the operator) without increasing beyond the dimensions of the vehicle the transverse footprint of the handler, which in turn is subject to the limitations imposed by the regulations governing road traffic.

Due to similar requirements, the ladder is also usually accommodated in a recess provided along the side of the vehicle, so as not to increase the transverse footprint of the vehicle (and of the handler).

In order to offer a second cab access option, an additional ladder is typically placed on the opposite side of the vehicle so that it is similarly aligned with the door when the cab is rotated through 180 degrees.

However, this embodiment is not free from drawbacks.

As a result of the already described alignment between the door and the side of the vehicle, when the operator has to get out of the cab with the handler in the travel arrangement (or with the cab rotated 180 degrees with respect to it), the very structure of the cab hides the ladder from the operator's view, forcing him to move in conditions of poor visibility, thus endangering his safety. Moreover, the step of accessing the cab (and opening the door in particular) in said arrangement can also be equally awkward.

Moreover, even when the cab is rotated at an intermediate angle with respect to the arrangements described above, the operator may have difficulty in getting into or out of the cab. In fact, as a result of the rotation the door may move significantly away from the nearest ladder, again making the task of climbing up or down awkward and dangerous.

The aim of the present invention is to solve the above problems by providing a rotary telescopic handler that allows an operator to get out of the cab in a practical and safe manner.

Within this aim, an object of the invention is to provide a rotary telescopic handler that offers the operator practical ways of getting in or out of the cab when said cab is arranged so as to be aligned with the side of the underlying vehicle.

Another object of the invention is to provide a rotary telescopic handler that allows the operator practical ways of getting in or out of the cab in any relative position assumed by the cab with respect to the vehicle.

Another object of the invention is to provide a rotary telescopic handler that ensures high reliability in operation.

Another object of the invention is to provide a rotary telescopic handler that adopts a technical and structural architecture that is alternative to those of known types of handler.

Not least object of the invention is to provide a rotary telescopic handler that can be obtained easily starting from commonly commercially available elements and materials.

Still another object of the invention is to provide a rotary telescopic handler that has low costs and is of assured application.

This aim, these objects and others that will become better apparent hereinafter are achieved by a rotary telescopic handler according to claim 1.

Further characteristics and advantages of the invention will become better apparent from the description of a preferred but not exclusive embodiment of the rotary telescopic handler according to the invention, illustrated by way of non-limiting example in the accompanying drawings, wherein:

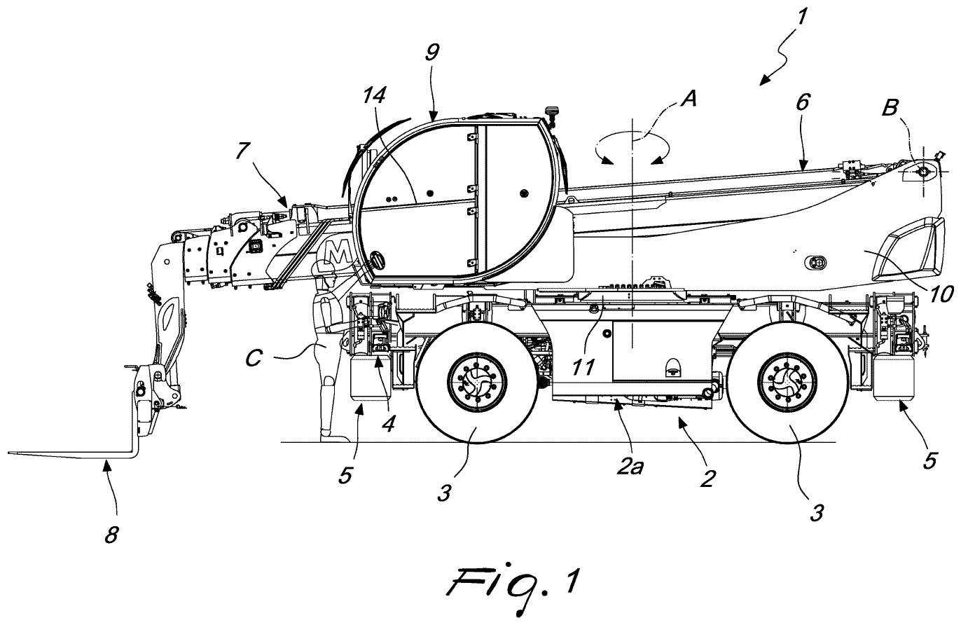

FIG. 1 is a lateral elevation view of the handler according to the invention in the travel arrangement;

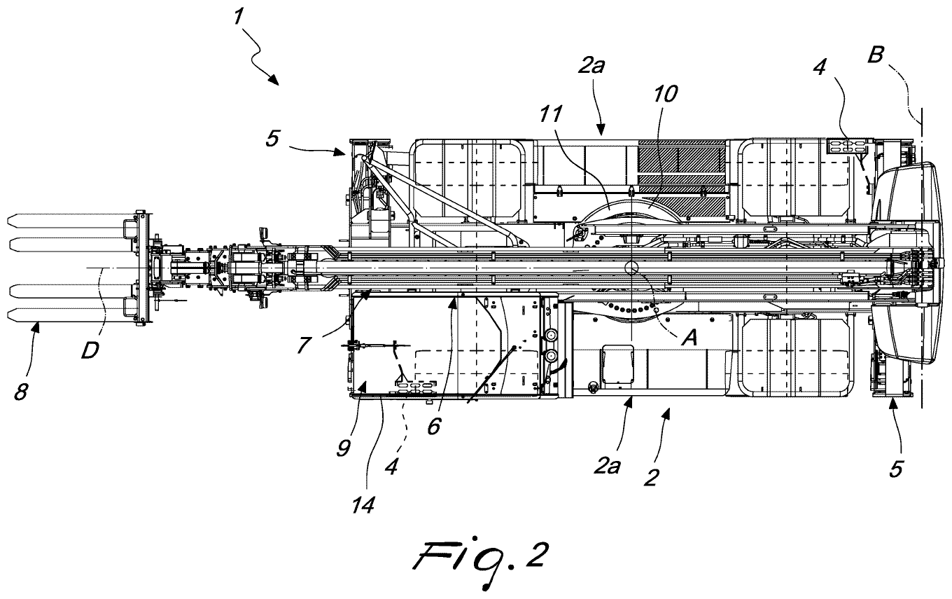

FIG. 2 is a top view of the handler in the travel arrangement of FIG. 1;

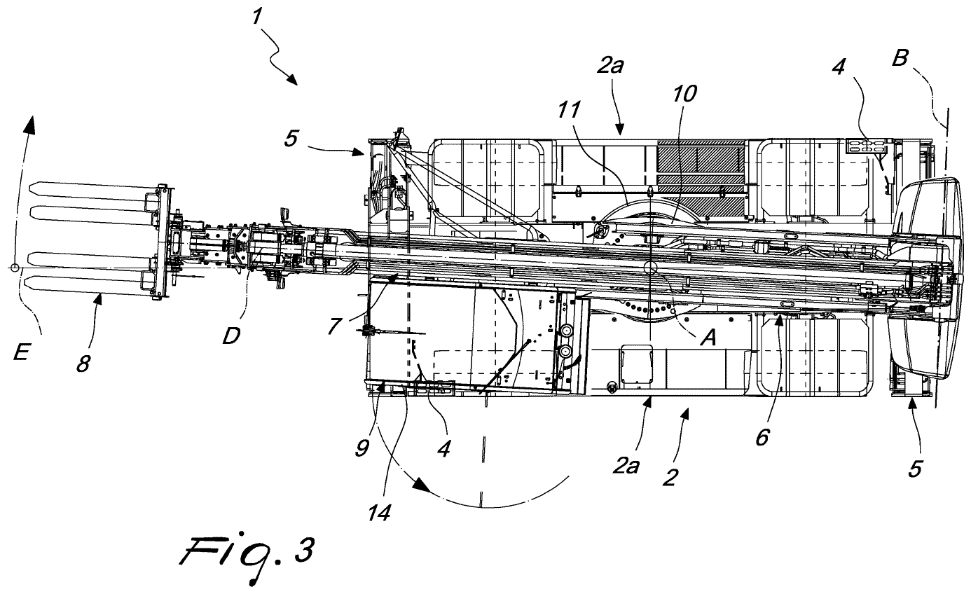

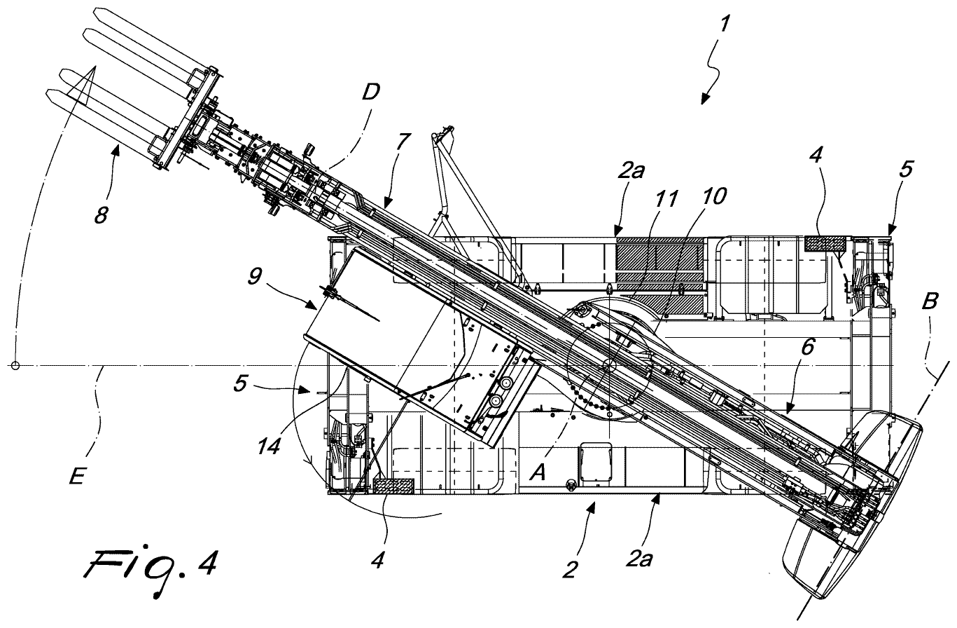

FIGS. 3-6 are top views of the handler of FIG. 1, as in FIG. 2 but in different relative positions of the rotating assembly with respect to the vehicle;

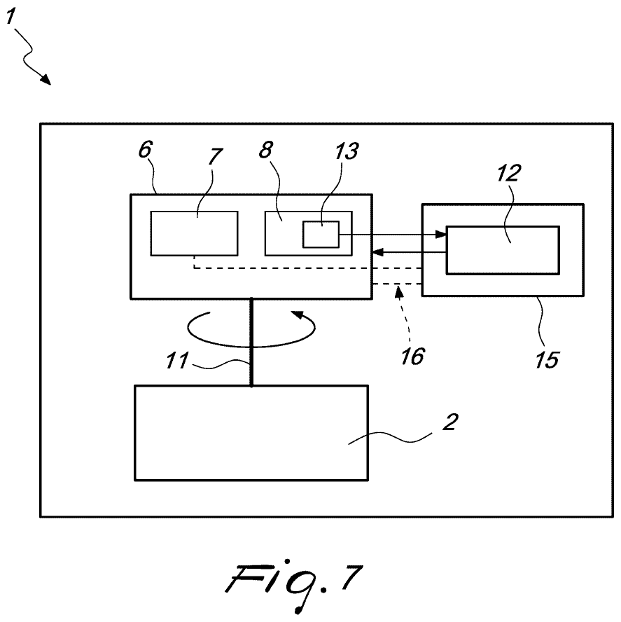

FIG. 7 is a block diagram of the handler according to the invention, showing the connections between some elements.

With reference to the cited figures, the reference numeral 1 generally designates a rotary telescopic handler, which comprises at least one vehicle 2, which can move on the ground (by virtue of wheels 3 or tracks) and is equipped with at least one ladder 4 placed along one of its side walls. It is specified that “side wall” is to be understood in the broadest (geometric) meaning, i.e., as any one of the walls extending from the bottom plane (up to the top): in the preferred, non-limiting case in which the vehicle 2 has a substantially parallelepipedal shape, as in the accompanying figures, one or more ladders 4 may therefore be arranged along the front wall, the rear wall, or (as indeed in the accompanying figures) along one or both sides 2a.

Typically, the ladders 4 are recessed into the respective wall (and in particular into the respective side 2a of the vehicle 2) so as not to increase the overall footprint of the vehicle 2.

More generally, however, the entire vehicle 2 can be of the traditional type and can be chosen so as to correspond to the embodiment (among the many widespread in the field) that the person skilled in the art would deem in each instance to be the most suitable for the purpose.

Moreover, in order to be able to bear high loads and ensure adequate support even during operations at high elevations, the vehicle 2 can be equipped with a stabilizing apparatus 5, which can also be chosen of a known type (and for example, therefore, of the scissor type, as in the accompanying figures).

Moreover, the handler 1 comprises at least one rotating assembly 6, which is supported by the vehicle 2 with the possibility of rotation about a vertical axis A.

The assembly 6 comprises at least one telescopic boom 7, which is adapted to support a work accessory 8. Typically, the boom 7 can rotate with respect to vehicle 2 about a horizontal axis B.

In the present description, the terms “horizontal” and “vertical” are of course to be understood as relative to the ground and, in any case, to the imaginary resting plane of the vehicle 2 and of the handler 1.

In well-known ways, the telescopic boom 7 is typically composed of a plurality of segments or extensions, which are arranged in series and are mutually extendable (hence the name); moreover, on the opposite side of the vehicle 2, the boom 7 provides a free end that can be coupled to the accessory 8 of interest. The accessory 8 can be of any type: in the accompanying figures, by way of example, it has been chosen to show an accessory 8 constituted by a fork; however, the accessory 8 could be any other object or tool suitable for the purpose for which the handler 1 is intended to be used (and it could also be a platform designed to accommodate a person).

The accessory 8 may also be interchangeable, so that it can be replaced at each operation, as a function of the specific requirements.

The accessory 8 or a set of accessories 8 may thus be comprised within the handler 1, but the protective scope claimed here also comprises handlers 1 without accessories 8, which can then be sourced separately.

Moreover, the possibility is not excluded that the handler 1 might be provided with two or more arms 7, which are for example mutually articulated.

Moreover, the assembly 6 comprises at least one cab 9, which is configured to accommodate an operator C, who inside said cab 9 can find a control panel that allows him to control the handler 1 and its functions.

More particularly, in the embodiment of the accompanying figures, provided by way of non-limiting example of the application of the invention, the assembly 6 comprises a base structure 10, connected (rotatably) to the vehicle 2 by means of a rotary joint 11: the boom 7 and the cab 9 are then mounted on the structure 10 (so that the boom can rotate, with respect to said structure 10, about the horizontal axis B).

More generally, the boom 7 and the cab 9 can be supported by the vehicle 2 either directly or indirectly (i.e., with the interposition of other components, as in the accompanying figures).

In any case, for all aspects not covered in detail in the present description, any construction detail relating to the vehicle 2, the apparatus 5, the assembly 6, the boom 7, the accessory 8, the cab 9, and anything else, may be of a known type. In particular, therefore, the person skilled in the art may choose in each instance the configuration and embodiment deemed most appropriate based on common expertise in the field and as a function of the specific requirements, without, however, abandoning the protective scope claimed herein.

According to the invention, the handler 1 comprises an electronic unit 12 associated with a respective actuation device 13, which can be activated selectively by an operator C.

The unit 12 is typically (but not exclusively) a control unit, a PLC, a computer, other hardware, reprogrammable or not (for example with a microprocessor); it is usually of a known type (apart from the particularities described herein) and is mounted on board the handler 1; it may also be the same one to which management of all the activities of the latter is entrusted. However, the possibility is not ruled out of providing a dedicated electronic unit 12, to be mounted on the handler 1 and exclusively assigned to the tasks described hereinafter. In this regard, it is specified that the functionalities described herein with reference to the electronic unit 12 may be implemented in practice by resorting to the mechanical, software and/or hardware components that the person skilled in the art would know how to choose, drawing on common expertise in the field.

In turn, the actuation device 13 can be of any type; for example, in one embodiment of considerable practical interest it can comprise a button, possibly of the touch type (or a lever, or the like), arranged in the cab 9. Even more particularly, the button is mounted on a joystick, which is located inside the cab 9 and is configured (in per se known manners) for driving the vehicle 2 and/or moving the assembly 6 and/or the boom 7 (as well as for the other management and control functions of the handler 1). Moreover, the functions performed by the button (or in any case by the device 13) are intended to be associated with all the safety systems (for example of the “deadman” type) that the person skilled in the art would know how to identify as useful or necessary for the safety of the operator C and of what surrounds the handler 1 and/or for compliance with regulations in the field.

According to the invention, the unit 12 is configured to actuate the rotation of the assembly 6 with respect to vehicle 2 about the vertical axis A. In other words, therefore, the unit 12 is associated with the actuators and the other systems that actuate and indeed allow the rotation of the assembly 6. Moreover, the unit 12 is provided with instructions to perform the automatic rotation of the assembly 6 with respect to the vehicle 2, following the activation of the device 13, to at least one predefined first arrangement, for facilitated access to the cab 9, in which a door 14 for access to the cab 9 faces and is proximate to the ladder 4. As will be clarified better hereinafter, in the handler 1 according to the invention only the first predefined arrangement might be provided and likewise the first and other predefined arrangements might be provided.

Unless otherwise specified, in the present description, when reference is made to the position of the door 14, this is intended as the position that it assumes when it closes the cab 9 (as in the accompanying figures).

In practice, therefore, as a result of the simple activation of the device 13 (activation that may consist in pressing a button, whether of the touch type or not, or pulling a lever) by the operator C, the unit 12 takes care of automatically rotating the assembly 6 until it is brought to a previously stored arrangement (for example, the first predefined arrangement, for facilitated access), chosen so as to allow easy transition, for the operator C, from the cab 9 to the ladder 4, or vice versa. In fact, as mentioned, in the first predefined arrangement the door 14 (when it closes the cab 9) faces and is proximate to the ladder 4, and by this condition it is meant that
the door 14 is at a close distance from the ladder 4 (a distance such as to allow the operator C aboard the cab 9 to locate the steps of ladder 4 and place one foot on the highest one without difficulty),
the ladder 4 is visible from door 14 and by an operator C who leans out of the cab 9, through the opening normally closed by the door 14 (therefore in the predefined arrangement the ladder 4, seen in plan view, protrudes from the footprint of the cab 9: the door 14 is not aligned with the ladder 4, nor does the cab 9 “cover”and hide the ladder 4 from view).

The person skilled in the art will therefore know how to choose a predefined arrangement (providing the electronic unit 12 with the instructions to reach it) in accordance with the indications given above.

It is also emphasized that in the present description the term “arrangement” indicates a specific position assumed by the assembly 6 with respect to the vehicle 2, with the different “arrangements” that can thus be obtained by means of the rotation of the assembly 6 with respect to the vehicle 2 about the vertical axis A.

The intended aim is thus achieved as of now: regardless of the relative position in which the assembly 6 is arranged (for example, chosen to perform the required task or corresponding to the one used for road travel), simply by acting on the device 13 (by pressing a button, for example) the operator C can automatically move the assembly 6 until the cab 9 is brought (in the predefined arrangement, previously set and stored, and therefore) to a position that allows to get in or out of it in a practical and safe way.

The possibility is provided that one or more predefined arrangement(s) are set at the time of assembly, programming and/or delivery of the handler 1, and likewise it is not excluded to equip the handler 1 with means for reprogramming the predefined arrangement(s), as a function of the specific requirements of each user.

In any case, the predefined arrangement is preferably stored in the unit 12 before each use of the handler 1, so that the operator C can take advantage of the functionalities shown here without having to perform any setup or programming procedure.

In particular, in an embodiment of considerable practical interest, the first predefined arrangement (visible in FIG. 3) corresponds to the arrangement that can be obtained by rotating the assembly 6 about the vertical axis A by a first predefined angle, with respect to the position assumed in a travel arrangement, in which (as in FIG. 2) the longitudinal axis D of the boom 7 is oriented along the longitudinal axis E of the vehicle 2 (and the accessory 8 is in front of the vehicle 2). More precisely, the breadth of the first predefined angle is chosen from one of the intervals 1°-10°, 10°-20°, 20°-30° (or even in an interval with higher values) as a function of the relative position of the door 14 with respect to the vertical axis A. Indeed, it should be noted that in the first predefined arrangement the door 14 must face and be proximate to the underlying ladder 4, causing the latter to protrude out of the footprint of cab 9: evidently, the closer the cab 9 is to the vertical axis A, the greater the breadth of the first angle must be, in order to allow it to move enough to “expose” the underlying ladder 4. Hence the possibility to choose the angle in intervals of different breadths. Moreover, the direction in which the assembly 6 must be rotated in order to obtain the first predefined arrangement starting from the travel arrangement is chosen such as to bring the ladder 4, located along a side 2a of vehicle 2, outside the footprint of the cab 9 (to allow operator C to see indeed the ladder 4 when he leans out of the cab 9).

The longitudinal axis D of the boom 7 is evidently the one along which its extensions can be pulled out telescopically, while the longitudinal axis E of the vehicle 2 is in practice the one that coincides with the direction of travel. The orientation of the longitudinal axis D of the boom 7 in practice indicates the straight line (indicated indeed by the reference “C” in FIGS. 2 and 3) obtained by the projection onto the imaginary resting plane of the boom 7 (the actual position of the latter being variable with rotation about the horizontal axis B).

In the accompanying figures, it is straightforward to note that the transition from the travel arrangement (FIG. 2) to the first predefined arrangement (FIG. 3) is achieved with a rotation of a few degrees clockwise (looking at the handler 1 from above).

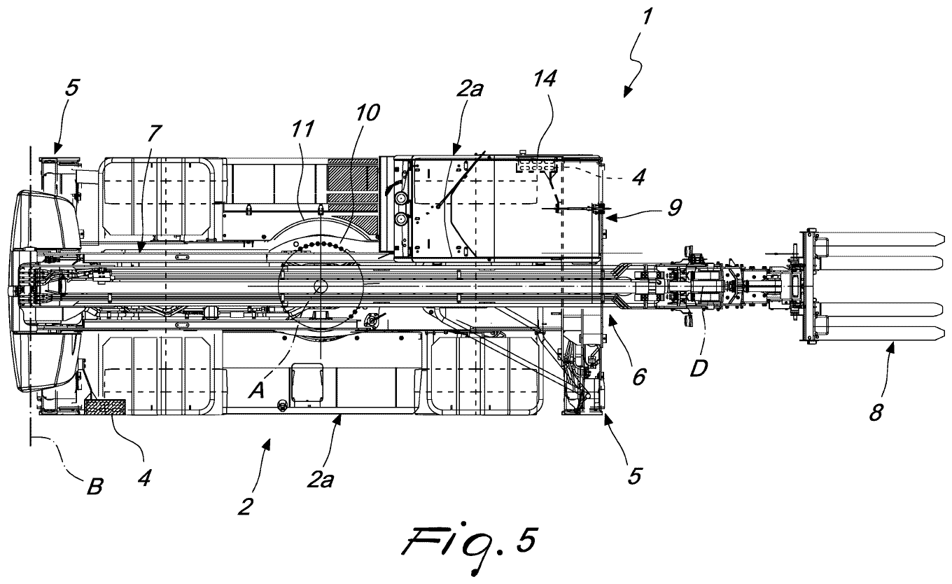

The travel arrangement (FIGS. 1 and 2) is typically the one that minimizes the footprint (in particular, in the direction that is transverse to the travel direction), so as to comply more easily with the regulations that indeed control road traffic. As FIG. 2 clearly points out, in this travel arrangement the longitudinal axis D of the boom 7 coincides indeed with the longitudinal axis E of the vehicle 2 and preferably the door 14 is aligned with a side 2a of the vehicle 2. FIG. 5 instead shows the arrangement obtained by rotating the assembly 6 through 180°, starting from the travel arrangement.

In particular, with reference to a configuration of the handler 1 such as the one shown in the accompanying figures, in which the cab 9 is significantly spaced from the vertical axis A (such that its front face is aligned with the front wall of vehicle 2, in the travel arrangement), the breadth of the first predefined angle is chosen in the interval 1°-10°. Preferably, it has been found that a result of high practical interest is obtained by choosing a breadth value of 3° for the first predefined angle. In any case, it is stressed that other values may be chosen without thereby abandoning the protective scope claimed herein.

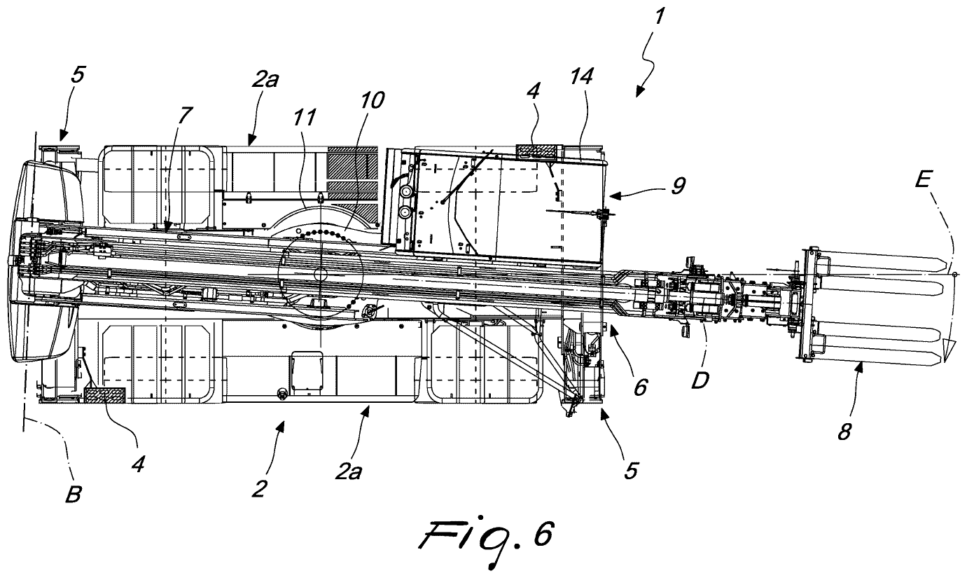

In the embodiment shown in the accompanying figures by way of non-limiting example of the invention, the handler 1 comprises at least a first ladder 4 and a second ladder 4 (there may also be others), which are located along respective sides 2a of the vehicle 2. In this embodiment, the unit 12 is thus provided with instructions to perform the automatic rotation of the assembly 6 with respect to the vehicle 2, following the activation of the device 13, to one between the first predefined arrangement, in which the door 14 faces and is proximate to the first ladder 4, and a second predefined arrangement (the one of FIG. 6), in which the door 14 faces and is proximate to the second ladder 4.

The criterion by which one chooses to program the unit 12 so that it automatically chooses toward which of the different predefined arrangements the assembly 6 is to be rotated toward may be any, as a function of the specific requirements (however, this does not preclude delegating the choice to the operator C, for example by providing the handler 1 with two or more separate activation devices 13, one for each predefined arrangement provided).

In any case, in an embodiment of considerable practical interest, the unit 12 is provided with instructions for the automatic rotation of the assembly 6 with respect to the vehicle 2, following the activation of the device 13, to the nearest of the predefined arrangements (in this way, the rotation imposed on the assembly 6 is made to be the shortest, and therefore the fastest, possible).

In particular, the second predefined arrangement corresponds to the arrangement that can be obtained with a rotation of the assembly 6 about the vertical axis A by a second predefined angle, with respect to the position assumed in the travel arrangement. The breadth of the second predefined angle is chosen in one of the intervals 180°-190°, 190°-200°, 200°-210° (or even in an interval with higher values) depending on the relative position of the door 14 with respect to the vertical axis A (the remarks made for the first predefined angle obviously apply to the choice of the specific interval to be referenced). Moreover, the direction of rotation, from the travel arrangement to the second predefined arrangement, is chosen such as to bring the second ladder 4 outside the footprint of the cab 9.

More simply, the second predefined arrangement (as in FIG. 6) may be the one that corresponds to a 180° rotation of the assembly 6 about the vertical axis A with respect to the first predefined arrangement.

More particularly, therefore, with reference to a configuration of the handler 1 such as the one shown in the accompanying figures, and similarly to what has been observed for the first predefined angle, the breadth of the second predefined angle is chosen in the interval 180°-190° and preferably is equal to 183°.

Usefully, the handler 1 comprises an electronic central control element 15, which may for example be a control unit, a computer, other hardware, which is reprogrammable or not (for example with a microprocessor) to which control of the entire handler 1 is entrusted. The electronic unit 12 may be included in the element 16 (as shown schematically by FIG. 7) or may in fact coincide with it (in this case, the element 16 therefore takes on the task of controlling the entire handler 1 and of actuating the rotation of the assembly 6 following the activation of the device 13 in the manners described so far).

The element 15 is provided with a BUS communication channel 16 to control at least the rotation of the rotating assembly 6 and the movement of the boom 7 (and possibly of all the other systems on board the handler 1, such as for example the stabilizing apparatus 5). The channel 16 allows the element 15 (or the unit 12) to interface with the components listed above or even with others, such as actuators, pumps, or other distribution systems or systems of another kind, in any case to coordinate their operation and optimally manage power delivery.

The operation of the rotary telescopic handler according to the invention is evident from what has already been described, but the following is a summary thereof.

In per se traditional manners, the vehicle 2 can move on the ground A (preferably in the travel arrangement of FIGS. 1 and 2) to reach the exact place and point where an intervention must be performed (usually at a certain height above the ground), for which use of the handler 1 (of the accessory 8 mounted on the boom 7) is indeed required. After reaching the point of intervention, it is possible to activate the apparatus 5 in order to obtain a more stable grip on the ground A, and in any case move the boom 7 (by rotating it and making the extensions mutually slide) and/or rotate the assembly 6, until the accessory 8 is brought to the exact point of intervention.

At any time, and in any position of the assembly 6 with respect to the vehicle 2 (in any “arrangement” of the assembly 6), the operator C can act on the device 13 (preferably located in the cab 9 for this purpose) in order to automatically bring the assembly 6 to a predefined arrangement, chosen such as to allow practical access to the ladder 4 from the cab 9, or vice versa.

In practice it has been found that the rotary telescopic handler according to the invention fully achieves the intended aim, since by virtue of the unit 12 capable of automatically bringing the assembly 6 to a predefined arrangement, as a consequence of the activation of the device 13, the operator C can climb down from the cab 9 in a practical, quick and safe manner.

The instructions with which the unit 12 is provided return the assembly 6 to a predefined arrangement, regardless of the starting arrangement; then, by activating the device 13, the handler 1 quickly moves to a condition that allows the operator C to climb down conveniently and safely from the cab 9, independently of the arrangement in which the assembly 6 was when the device 13 was activated. Therefore, the handler 1 offers the operator C practical ways to climb down from the cab 9 when the latter is aligned with the side 2a of the underlying vehicle 2 as well as in any other relative position assumed by the cab 9 relative to the vehicle 2.

Obviously, climbing back into (or climbing into) the cab 9 is also facilitated.

The invention thus conceived is susceptible of numerous modifications and variations, all of which are within the scope of the appended claims; all the details may furthermore be replaced with other technically equivalent elements.

In the embodiments shown, individual characteristics, given in relation to specific examples, may actually be interchanged with other different characteristics that exist in other embodiments.

In practice, the materials used, as well as the dimensions, may be any according to the requirements and the state of the art.

The disclosures in Italian Patent Application No. 102022000016590 from which this application claims priority are incorporated herein by reference.

1.-10. (canceled)

11. A rotary telescopic handler, comprising at least one vehicle, which is configured to move on the ground and is provided with at least a ladder arranged along one of its side walls, and a rotating assembly, which is supported by said vehicle with a possibility of rotation about a vertical axis, said assembly comprising at least one telescopic boom, adapted to support a work accessory, and a cab, configured for accommodation of an operator,
and further comprising an electronic unit associated with a respective actuation device, which can be activated selectively by an operator, said electronic unit being configured to actuate a rotation of said rotating assembly with respect to said vehicle about said vertical axis and being provided with instructions for an automatic rotation of said rotating assembly with respect to said vehicle, following an activation of said actuation device, to at least a first predefined arrangement, for facilitated access to said cab, wherein a door for access to said cab faces said ladder and is proximate thereto.

12. The handler according to claim 11, wherein said first predefined arrangement corresponds to an arrangement that can be obtained with a rotation of said rotating assembly about said vertical axis by a first predefined angle, with respect to a placement assumed in a travel arrangement, in which a longitudinal axis of said boom is oriented along a longitudinal axis of said vehicle, a breadth of said first predefined angle being chosen in one among intervals 1°-10°, 10°-20°, 20°-30° as a function of the relative position of said door with respect to said vertical axis, a direction of rotation of said assembly, from said travel arrangement to said first arrangement, being chosen such as to move said ladder, arranged along one side of said vehicle, out of a footprint of said cab.

13. The handler according to claim 12, wherein the breadth of said first predefined angle is chosen in the interval 1°-10° and is preferably equal to 3°.

14. The handler according to claim 12, further comprising at least one first said ladder and a second said ladder, which are arranged along respective said sides of said vehicle, said unit being provided with instructions for the automatic rotation of said rotating assembly with respect to said vehicle, following the activation of said actuation device, to one between said first predefined arrangement, in which said door faces said first ladder and is proximate thereto, and a second predefined arrangement, in which said door faces and is proximate to said second ladder.

15. The handler according to claim 14, wherein said electronic unit is provided with instructions for the automatic rotation of said rotating assembly with respect to said vehicle, following the activation of said actuation device, to the closest among said predefined arrangements.

16. The handler according to claim 14, wherein said second predefined arrangement corresponds to an arrangement that can be obtained with a rotation of said rotating assembly about said vertical axis through a second predefined angle, with respect to the placement assumed in said travel arrangement, the breadth of said second predefined angle being chosen in one among the intervals 180°-190°, 190°-200°, 200°-210° as a function of a relative position of said door with respect to said vertical axis, a direction of rotation of said assembly, from said travel arrangement to said second arrangement, being chosen such as to move said second ladder out of the footprint of said cab.

17. The handler according to claim 16, wherein the breadth of said second predefined angle is chosen in the interval 180°-190° and is preferably equal to 183°.

18. The handler according to claim 11, wherein said actuation device comprises a button arranged in said cab.

19. The handler according to claim 18, wherein said button is mounted on a joystick which is arranged inside said cab and is configured to drive said vehicle and/or move said rotating assembly and/or said boom.

20. The handler according to claim 11, further comprising an electronic central control element, provided with a BUS communication channel for controlling at least the rotation of said rotating assembly and the movement of said boom.
